(19) United States
(12) Patent Application Publication
(10) Pub. No.: US 2005/0258303 A1
(43) Pub. Date: Nov. 24, 2005

(54) Flying craft tethered to powered water vehicles

(76) Inventor: Neil Graham, Carlsbad, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/192,145

(22) Filed: Jul. 28, 2005

Related U.S. Application Data
(63) Continuation-in-part of application No. 10/808,639, filed on Mar. 24, 2004, now Pat. No. 6,938,852.

(51) Int. Cl. B64D 5/00

(52) U.S. Cl. 244/2

(57) ABSTRACT

A flying vehicle assembly apparatus comprises a winged flying craft and a powered craft comprising two or more hulls for propelling the flying craft, and a biased tether assembly comprising one or more first rigid struts having a first end pivotally secured to pivot connections adjacent to the flying craft and a second end pivotally secured to a hinge assembly, and one or more second rigid struts having a first end pivotally secured adjacent to the powered craft and a second end pivotally secured to a biased hinge assembly. The biased tether assembly urges the flying craft and the powered crafts toward one another whereby at least a portion of said powered craft is beneath the flying craft, and whereby during flying operation, the powered craft is generally forward of the flying craft.

This application is a continuation-in-part of application Ser. No. 10/808,639, filed Mar. 24, 2004.

### FIELD OF THE INVENTION

The apparatus described herein is related to a winged flying craft which is tethered to a powered craft. The powered craft is operated by a user from the flying craft.

### BACKGROUND OF THE INVENTION

A number of tethered flying crafts powered with a land or water propelled vehicles have been proposed. Examples of such driven vehicles are disclosed in U.S. Pat. Nos. 1,825,363; 4,417,706; and 5,082,198. The apparatus described in the aforesaid patents require complex tether assemblies incorporating a plurality of rods or poles having one end attached to the flying craft and the other to the powered craft. It is to the improvement of such tethered flying vehicle assemblies that the present apparatus is directed.

### SUMMARY OF THE INVENTION

The apparatus described herein is an assembly including a winged flying craft having a cabin for accompanying an operator, and one or more powered craft water vehicles to which it is tethered. A preferred powered craft comprises two or more shaped hulls.

### BRIEF DESCRIPTION OF THE DRAWINGS

FIG. 1 is a perspective view of the flying vehicle assembly showing the winged flying craft, a twin hulled powered craft for operating the assembly and the tether assembly;

FIG. 2 is a perspective view of a flying vehicle assembly showing an alternative tether embodiment;

FIG. 3 is a side view of the assembly of FIG. 2 partially cutaway illustrating the tether assembly and biased hinges connecting the powered craft and the flying vehicle; and

FIG. 4 is a side view of the assembly of FIG. 3, partially cutaway to show the tether assembly components in a folded position as urged by biased pivot or hinge tether connections.

### DETAILED DESCRIPTION OF THE PREFERRED EMBODIMENT

In aforesaid application Ser. No. 10/808,639, incorporated herein by reference in its entirety, a flying craft tethered to a powered vehicle is described. In the present application the use of a multiple hulled water craft or multiple water vehicles is described. Preferably, the water craft incorporates two or more hulls for improved stability. Referring to the drawings, the flying vehicle assembly is shown comprising a winged flying craft 12 having wings 14 and 16 on each side of the body 15 of the flying craft. The wings are preferably each attached to the sides of the body of the flying craft, and rearwardly of the center of the body of the flying craft. The center of the flying craft is defined herein as the center of gravity of the flying craft, and is forward of the center of lift of the flying craft, the later being over the wings. Thus, the center of lift of the flying craft is along an axis extending through both of the wings, typically through the wing tips, thus, the center of gravity is forward of the wings and the center of lift is aft or to the rear of that position.

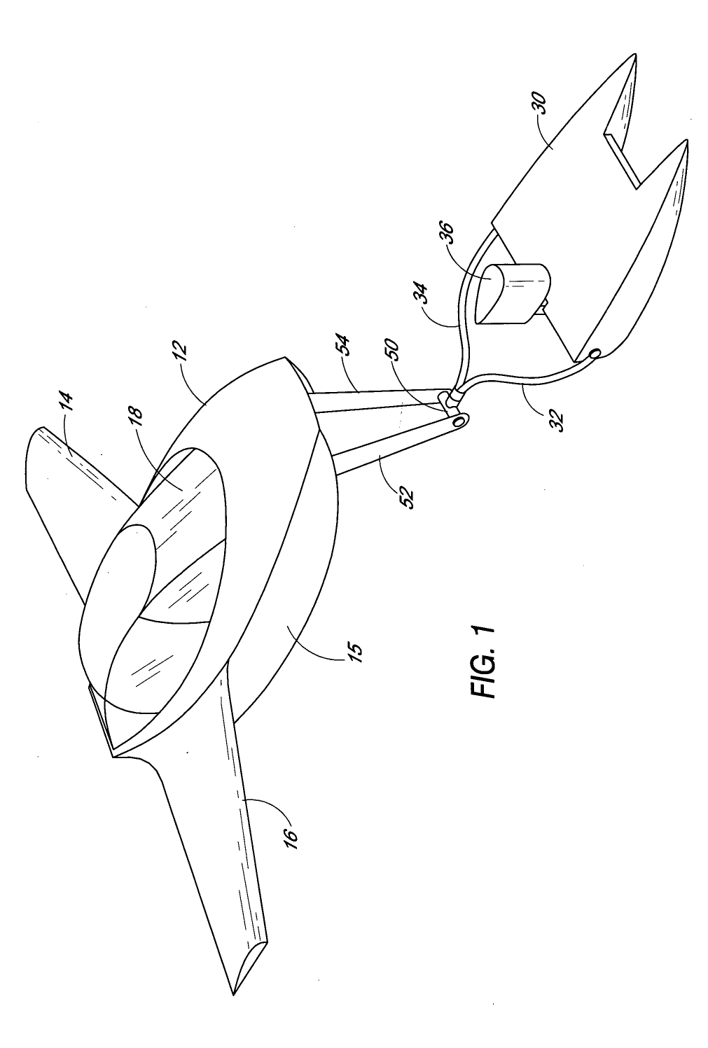

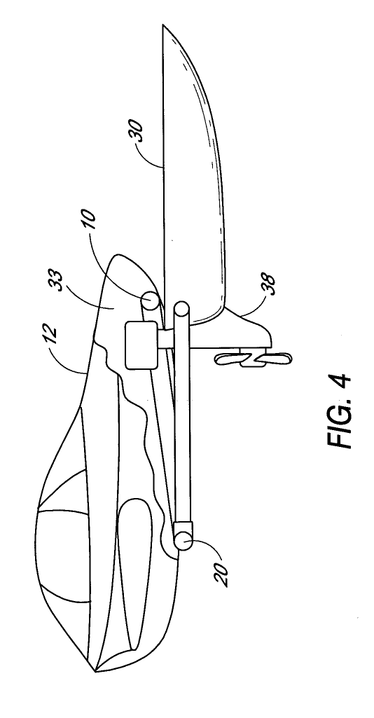

The embodiment shown in FIG. 1 utilizes a single powered vehicle, preferably a double or twin hulled water craft 30. The tether assembly includes a pair of first rigid struts 52 and 54, pivotally secured or hinged to the flying craft as described in the aforesaid apparatus Ser. No. 10/808,639. Second rigid struts 32 and 34 are attached to the water craft. The first and second rigid struts are secured to an intermediate hinge assembly 50, also described in the aforesaid application. One or more of the hinged connections of the tether assembly securing ends of the first rigid struts and ends of the second rigid struts are biased whereby the powered craft and the flying craft are urged toward a position in which the rigid tether struts are folded as shown in FIG. 4 and as described in the aforesaid application. The terms biased and biasing as used herein are intended to include mechanical biasing means, members or components such as one or more springs, pistons, tensioners or other devices which exert a force, stress or torque to promote or resist movement or displacement. Such biased or biasing means may be components of the tether assembly or otherwise cooperate with the tether assembly to urge the flying craft and powered craft together in the preflight configuration such as illustrated in FIG. 4 and/or to resist movement of the two crafts from their respective preflight positions.

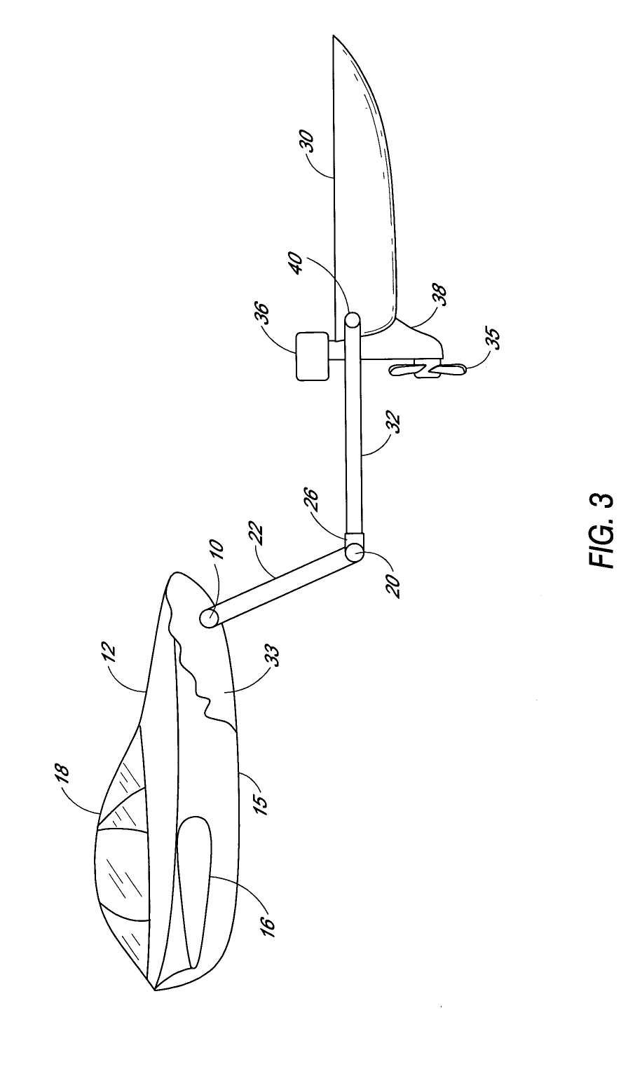

The apparatus shown in FIG. 1 comprises powered twin hulled water craft 30 provided with a motor 36 which drives a propeller for powering the craft through the water. Although a land traveling vehicle could be used, because of land traffic congestion and limited areas where such an apparatus could be used, water powered crafts are preferred. Such a twin hulled water craft, e.g. a catamaran, may be powered by a single engine, inboard or outboard, or by multiple such engines. Observing also FIG. 3, the powered craft includes a propeller 35 and rudder 38 and the operation of the motor and rudder are controlled from the flying craft 12 by an operator positioned in a cockpit 18. Specific controls, including electronic and radio control features known to those skilled in the art, may be used and are not described in detail herein. The tether assembly and components are described in the aforesaid application Ser. No. 10/808,639. A water craft having three hulls, such as a trimaran, or more than three hulls, may also be used.

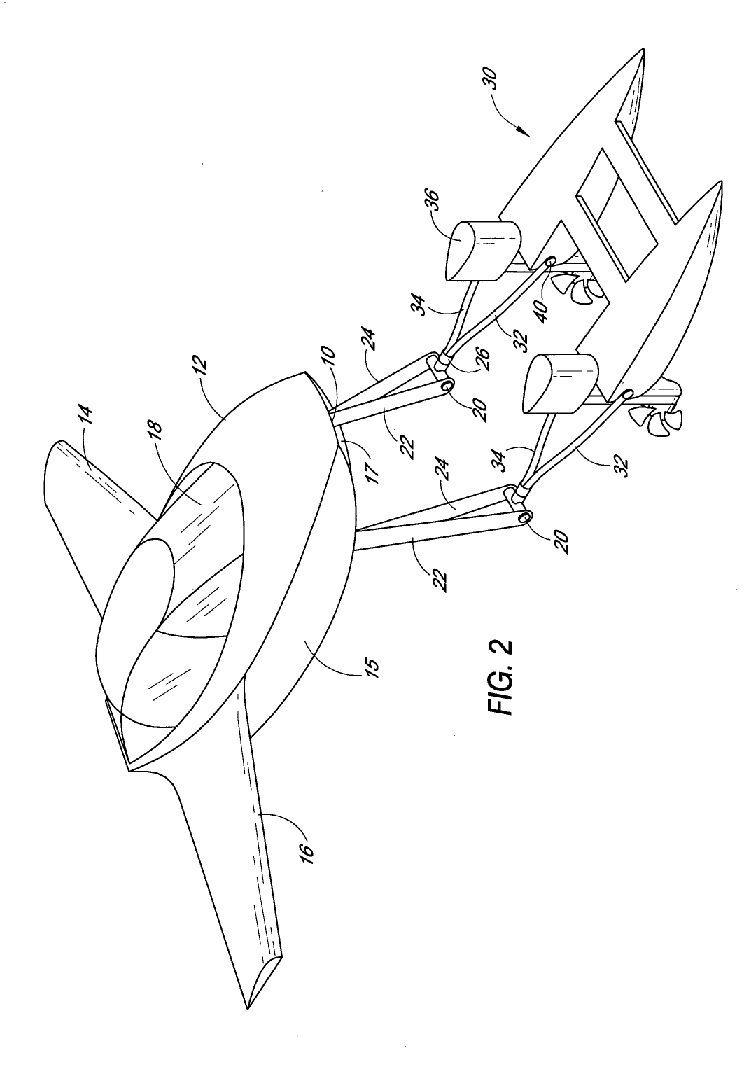

In the embodiment shown in FIG. 2 the powered vehicle comprises a twin hulled water craft having two engines. The structure of the watercraft includes suitable frame and support members securing the two hulls together. A tether assembly for attaching the flying craft and each powered craft hull comprises first rigid struts 22 and 24 and second rigid struts 32 and 34. Preferably, one first rigid strut and two second rigid struts are used for each powered craft hull, although one or more first rigid struts and one or more second rigid struts could be used in the tether assembly per hull. In the preferred embodiment illustrated, first rigid struts 22 and 24 are secured to the flying vehicle on its underside, forward of the wings and also forward of the center of gravity of the flying craft. One end of each of the first rigid struts 22 and 24 is secured to the flying craft at a pivot connection or hinge.

In FIGS. 3 and 4, a portion of the underside of the flying craft has been cut away to show connection of the tether assembly for one of the powered craft hulls. Observing FIG. 3, one end of rigid struts 22 and 24 are secured to flying craft 12 at pivot connection 10. The pivot position is preferably at the forward underside of the flying craft, and aft of the nose of the flying craft, and forward of the center of gravity. The end of each rigid strut opposite the end attached to the flying craft is secured at hinge assembly 20. The pivot connections or hinges at the ends of the respective struts may include bearings, e.g., journaled bearings, ball or roller bearings, seals, gaskets, bushings, pivot pins or bolts, and other suitable components known to those skilled in the art. Although two first rigid struts are shown, for attaching each powered craft hull to the flying craft, a single strut or multiple struts may be used.

Also secured at each hinge assembly 20 are second rigid struts 32 and 34. In the preferred embodiment illustrated, each of the second rigid struts 32 and 34, are attached to a connector 26 rotatably or pivotally secured to hinge assembly 20. Opposite ends of the second rigid struts 32 and 34 are secured to a hull of a powered craft (30, 31) by suitable means such as a pivot pin 40 as illustrated. Preferably, the ends of the second rigid struts 32 and 34 are secured to the powered craft at pivot connections so that the powered craft is free to move or pivot along a vertical plane relative to a horizontal plane extending through both of the rigid struts 32 and 34. Moreover, in the preferred embodiment illustrated, the ends of the second rigid struts 32 and 34 are pivotally secured to a connector 26, whereby each powered craft is also able to rotate on a horizontal plane axis relative to first rigid struts 22 and 24 and flying craft 12.

Other equivalent means for securing the ends of second rigid struts may be used. For example, the ends of struts 32 and 34 may be secured to a yoke device which is attached to the powered craft. Such a yoke may be hinged to the powered craft, and may also provide pivotal or rotatable attachment for the second struts relative to the yoke and/or powered craft.

One or more of the hinged or pivot connections are biased. Preferably, pivot connections 10 securing an end of a first rigid strut to the flying craft are biased to urge the first rigid struts toward the underside of the flying craft as shown in FIG. 4. Examples of such biasing components include a spring or a resistance provided by a hydraulic piston or pneumatic piston that resists movement of the hinge or pivot components connecting the first rigid struts 22 and 24 at the flying craft (pivot connection 10). Biasing may be linear or progressive. Biasing of hinge assembly 20 is optimal as is biasing of the pivots connecting the ends of second rigid struts 32 and 34 to the water craft. It may be useful to bias the rotatable connection between connector 26 and hinge assembly 20 whereby rigid struts 32 and 34 are biased along a horizontal plane. For example, one or more biasing springs cooperating with connector 26 and hinge assembly 20 may be used to urge the components to resist angular rotation thereby urging vertical alignment of the flying craft with the powered craft.

As shown in FIGS. 3 and 4, the bias at pivot connections 10 provides a scissor-like effect between the first rigid struts 22 and 24 and the second rigid struts 32 and 34. The pivot positions are biased so that the first rigid struts 22 and 24 are urged to the aft of the flying craft and whereby the hinge assemblies 20 are urged rearwardly of the apparatus. Again, bias of pivot connection 10 alone may be sufficient. Thus, in the most preferred embodiment, with pivot connection 10 so biased, the tether assembly is biased to urge the first and second rigid struts to form an acute angle relative to each hinge assembly 20 and ultimately to positioning of the flying craft and powered craft as shown in FIG. 4 when the powered craft is not operating. In this configuration, the biased tether assembly urges the powered water craft and flying craft together so that at least a portion of the water craft is located underneath the flying craft. Biasing of the pivot and hinge connections preferably uses spring, hydraulic or pneumatic biasing components which may be attached to or otherwise cooperate with the hinge or pivot components and/or to the struts. The specific design of the biasing components and the biased connectors is not critical as long as the intended operation is achieved.

As also illustrated in FIG. 4, the underside of flying craft 12 is preferably recessed or shaped so as to form a cavity 33 for receiving a portion of the powered craft in a non-operating or pre-flight condition. In such a condition, with the flying craft and powered craft closest together, and in a type of nested configuration, storage, trailering or other transporting, and prior to launching operation are improved and facilitated. The flying craft may include a pair of pontoons on its underside with the space between the pontoons for receiving the powered crafts. Alternatively, the powered craft may be attached to the outside of the pontoons.

In operation, the flying vehicle assembly apparatus shown may be launched by directing each of the craft into the water at a convenient launch site. Preferably, the flying craft is also watertight and shaped so as to minimize resistance of the flying craft as it is pulled through the water, at least for a short distance during initial takeoff. To initiate takeoff, an operator will control the direction and speed of the powered craft sufficiently whereby at a certain speed, the winged flying craft will become airborne. Prior to takeoff, the position of the flying craft and the powered craft may be as shown in FIG. 4, or the flying craft may be in the water behind the powered craft, with the tether assembly stretched between the two crafts with the first and second rigid struts lying generally along the same horizontal axis. If the FIG. 4 preflight configuration exists, during takeoff the acute angle between the first rigid struts and second rigid struts will increase as the winged flying craft is initially pushed in a forward direction by the driven powered craft via the struts, and as it becomes airborne is pulled along the direction of travel by the operation of the powered crafts, again via the struts. If the flying craft is behind the powered craft before takeoff, initially the flying craft will be pulled through the water until it becomes airborne and thereafter the biased tether assembly will urge the flying craft toward the powered craft and an operating configuration as shown in FIG. 1. In a straight direction of travel, the powered craft will pull the flying craft in a direction along the same vertical plane along with the flying craft positioned above and rearwardly of the powered craft. The elevation of the flying craft above the water will depend on the speed of the powered craft and the length of the rigid struts. An operator may control the direction and speed of the powered craft, whereby altitude of the flying craft may also change as the direction and speed are changed. With at least one of the connections along the tether assembly as previously described, the flying craft may also be banked during a turn.

The wings of the flying craft may be provided with flaps for operation so that the operator may increase or decrease the elevation of the flying craft or distance above the water somewhat, without unduly interfering with the overall operation of the apparatus. For example, especially during takeoff or landing, such flaps may be of assistance in improving takeoff thereby reducing the strain and speed of the powered craft for lifting the flying craft. Similarly, such flaps may also assist in lowering the flying craft, independently of the speed of the powered crafts.

The tether assembly described herein may be used/or flying craft assembly with single hull or multiple hull water craft. Although twin hull powered craft designs such as illustrated are preferred, other multiple hull designs may be used. Alternatively, independent powered crafts may instead be used. The speed and direction of each independent powered craft may be separately controlled by an operator whereby turning control of the apparatus may be enhanced and turning radius decreased.

1. A flying vehicle assembly apparatus comprising:
a winged flying craft for flying along a direction of travel;
one or more powered crafts tethered to said flying craft for propelling said flying craft along said direction of travel; and
a tether assembly comprising first rigid struts having a first end secured to a pivot connection adjacent to said flying craft and a second end secured to a hinge assembly, and second rigid struts having a first end pivotally secured adjacent to said powered craft and a second end secured to said hinge assembly, wherein said pivot connection and/or said hinge assembly are biased to urge said flying craft and said powered crafts together in a preflight condition.

2. An apparatus of claim 1 comprising a powered craft having two or more hulls.

3. An apparatus of claim 2 comprising a separate tether assembly secured between each of said powered craft hulls and the flying craft.

4. An apparatus of claim 2 wherein said flying craft has a forward end and a wing extending on each side of said flying craft rearwardly of said forward end with a lift axis defined along said wings, and wherein said pivot connections and said hinge assemblies are biased.

5. An apparatus of claim 2 wherein an underside of said flying craft is shaped to receive a portion of said powered craft in a nested position therewith; and wherein said first and second biased pivot connections are biased for urging said powered craft in nested position with said flying craft.

6. An apparatus of claim 2 wherein the underside of said flying craft includes a recess for receiving said powered craft in a nested position.

7. An apparatus of claim 2 wherein said powered craft comprises one or more engines for driving said powered craft through water and a controllable rudder for changing direction of water travel.

8. An apparatus of claim 7 wherein said engine and said rudder are controlled from said flying craft.

9. An apparatus of claim 2 wherein said tether assembly is biased and urged to a first position prior to operating said powered craft whereby said first and second rigid struts form a first angle with one another, and a second position during operation of said powered craft whereby said first and second rigid struts form a second angle with one another.

10. An apparatus of claim 9 wherein at least a portion of said powered craft is located underneath said flying craft with said tether assembly in said first position.

11. A flying vehicle assembly apparatus comprising:
a winged flying craft for flying generally along a direction of travel;
a powered craft comprising two or more shaped hulls for propelling said flying craft; and
one or more tether assemblies secured between said powered craft and the flying craft, each tether assembly comprising one or more first rigid struts having a first end pivotally secured to said flying craft and a second end secured to a hinge assembly, and one or more second rigid struts having a first end pivotally secured adjacent to said powered craft and a second end secured to a hinge assembly, whereby said tether assembly is biased to urge said flying craft and said powered crafts together in a preflight condition; and wherein said tether assembly operates between a first position prior to operating said powered craft whereby said first and second rigid struts form a first angle with one another, and a second position during operation of said powered craft whereby said first and second rigid struts form a second angle with one another.

12. An apparatus of claim 11 wherein said flying craft has a forward end and a wing extending on each side of said flying craft rearwardly of said forward end with a lift axis defined along said wings, and wherein said one or more first biased pivot connections are biased and secured to said flying craft at a location forward of said lift axis.

13. An apparatus of claim 12 wherein an underside of said flying craft is shaped to receive a portion of said powered craft in a nested position therewith.

14. An apparatus of claim 13 wherein said tether assembly is biased for urging said powered craft in said nested position with said flying craft.

15. An apparatus of claim 11 wherein at least a portion of said powered craft is located underneath said flying craft with said tether assembly in said first position.

16. An apparatus of claim 111 wherein said powered craft has one or more engines for driving said powered craft through water and a controllable rudder for changing direction of water travel.

17. An apparatus of claim 16 wherein said engine and said rudder of said powered craft are controlled from said flying craft.
